(19) United States
(12) Patent Application Publication
(10) Pub. No.: US 2021/0270615 A1
(43) Pub. Date: Sep. 2, 2021

(54) METHOD OF DETERMINING MOVING PATH BASED ON PREDICTIVE PATH AND MOBILE ITS STATION THEREFOR

(71) Applicant: LG ELECTRONICS INC., Seoul (KR)

(72) Inventors: Soyoung KIM, Seoul (KR); Xavier PUNITHAN, Seoul (KR)

(73) Assignee: LG ELECTRONICS INC., Seoul (KR)

(21) Appl. No.: 16/097,912

(22) PCT Filed: May 28, 2018
(86) PCT No.: PCT/KR2018/006005

§ 371 Date: Oct. 31, 2018

Related U.S. Application Data
(60) Provisional application No. 62/517,982, filed on Jun. 11, 2017.

(51) Int. Cl. G01C 21/34; G08G 1/0968

(52) U.S. Cl. CPC G01C 21/3415; G08G 1/0968

(57) ABSTRACT

A method of determining a moving path, which is determined by a mobile ITS (intelligent transport system) station, and an apparatus therefor are proposed. The mobile ITS station transmits a first message including at least one of (a) information on one or more predictive locations and (b) a kinematic predictive value at the one or more predictive locations in consideration of a first predictive moving path of the mobile ITS station, receives anticipated traffic information, which is generated in consideration of the first message, via a second message, and determines whether to change the first predictive moving path with a second predictive moving path based on the anticipated traffic information received via the second message.

### BACKGROUND OF THE INVENTION

### Field of the Invention

The present specification relates to an operation of a mobile ITS (intelligent transport system) station, and more particularly, to a method of determining a moving path, which is determined by a mobile ITS station based on a predictive path, and a configuration of the mobile ITS station.

### Discussion of the Related Art

Traditionally, a vehicle functions as means of transportation of a user. Yet, various sensors and electronic devices are mounted on the vehicle for the convenience of the user to provide driving convenience to the user. In particular, an ADAS (advanced driver assistance system) for the driving convenience of the user as well as an autonomous vehicle are actively developing.

The technologies for the ADAS and the autonomous vehicle have started from an initial sensing-based technology and a service range of the technologies is expanding based on V2X (vehicle-to-everything) communication.

The V2X corresponds to a technology containing a V2V (vehicle-to-vehicle), V2I (vehicle-to-infrastructure), V2P (vehicle-to-pedestrian), and the like. The V2X is developing via a standardization procedure in IEEE and 3GPP described in the following.

First of all, IEEE has developed WAVE (wireless access for the vehicular environment) in 2010 and the WAVE is a concept including description for a physical layer and a MAC layer for vehicle communication in a form of IEEE 802.11p and description for security, network management, and the like in a form of IEEE 1609. Meanwhile, based on the abovementioned technology, a DSRC (dedicated short-range communication) technology has been recently developed as an application technology for an ITS (intelligent transport system) related to road safety. Recently, ETSI has developed ITS-G5 based on the aforementioned technology. The ITS-G5 corresponds to a technology for a higher layer to perform V2V communication. A lower layer is still using a legacy IEEE 802.11p technology.

Meanwhile, 3GPP has announced a mode 3/4 as a mode for V2X in LTE Release 14 by expanding a technology for a previously provided sidelink. Moreover, NR (New RAT) corresponding to 5th generation communication is studying on a technology for V2V communication under the name of eV2X.

### SUMMARY OF THE INVENTION

A moving path of a vehicle is determined by a navigation system installed in the vehicle. Recently, it is able to determine a moving path to which real-time traffic information is reflected to avoid a congested path.

According to one embodiment of the present invention, a moving path of a vehicle can be more efficiently determined in consideration of a predictive moving path of a V2X vehicle in accordance with the development of V2X technology instead of simply determining a moving path of a vehicle based on current traffic information. To this end, embodiments of the present invention propose a method of efficiently determining a moving path of a vehicle by enhancing a legacy V2X technology, a transmission scheme of a message and a structure for the method, and an ITS station configuration for supporting the same.

Technical tasks obtainable from the present invention are non-limited the above-mentioned technical task. And, other unmentioned technical tasks can be clearly understood from the following description by those having ordinary skill in the technical field to which the present invention pertains.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to one embodiment, a method of determining a moving path of a mobile ITS (intelligent transport system) station includes the steps of transmitting a first message including at least one of (a) information on one or more predictive locations and (b) a kinematic predictive value at the one or more predictive locations in consideration of a first predictive moving path of the mobile ITS station, receiving anticipated traffic information, which is generated based on the first message, via a second message, and determining whether to change the first predictive moving path with a second predictive moving path based on the anticipated traffic information received via the second message.

The first message can be generated based on information obtained from a navigation service of the mobile ITS station.

The first message can include an identifier corresponding to information on each predictive location, data efficient time, message generation time, and information on a probability of passing through the each predictive location.

A set of the information on each predictive location and the information on the probability of passing through the each predictive location can be included in the first message only when a value of the information on the probability is equal to or greater than a prescribed criterion.

The second message can include density information per predictive location which is generated in consideration of information on predictive locations received from a plurality of stations including the mobile ITS station.

The first message can include information on arrival anticipated time corresponding to each of the information on the one or more predictive locations and the second message can include anticipated traffic information which is generated in consideration of the information on each of the predictive locations and the information on the arrival anticipated time.

The first message can be transmitted via a CAM (cooperative awareness message) by additionally including information on a current location and kinematic information corresponding to the current location.

The second message can be received in a form of an LDM (local dynamic map) including anticipated traffic information, which is generated in consideration of at least one selected from the group consisting of information on a current location, kinematic information corresponding to the current location, the information on the predictive location, and a kinematic predictive value at the predictive location.

The mobile ITS station can periodically transmit the first message. If the mobile ITS station changes the first predictive moving path with the second predictive moving path in a first period according to a transmission of the first message and a reception of the second message, the first message transmitted in a second period can include information which is generated in consideration of the second predictive moving path.

If the mobile ITS station transmits an emergency signal at the timing corresponding to a period for which the first message is transmitted, the mobile ITS station can transmit the emergency signal by assigning a higher priority to the emergency signal.

To further achieve these objects and other advantages and in accordance with the purpose of the invention, as embodied and broadly described herein, according to a different embodiment, a mobile ITS (intelligent transport system) station determining a moving path based on information on a predictive location includes a transceiver configured to transmit a first message including at least one of information on one or more predictive locations and a kinematic predictive value at the one or more predictive locations in consideration of a first predictive moving path of the mobile ITS station and receive anticipated traffic information, which is generated based on the first message, via a second message, and a processor configured to generate the first message and provide the first message to the transceiver, the processor configured to receive the second message from the transceiver and process the second message, the processor configured to determine whether to change the first predictive moving path with a second predictive moving path based on the anticipated traffic information received via the second message.

The mobile ITS station can further include a navigation system configured to provide a navigation service. In this case, the processor can generate the first message based on information obtained from the navigation system.

The processor can include an application for determining a moving path based on a predictive location in an application layer, a message management function block for managing the first message, and a function block for managing the second message.

The message management function block for managing the first message can include a CAM (cooperative awareness message) management function block and the function block for managing the second message can include an LDM (local dynamic map) management function block.

To further achieve these objects and other advantages and in accordance with the purpose of the invention, as embodied and broadly described herein, according to a further different embodiment, a method of assisting a mobile ITS station in determining a moving path includes the steps of receiving a first message including at least one of (a) information on one or more predictive locations and (b) a kinematic predictive value at the one or more predictive locations which are generated in consideration of a predictive moving path of each of one or more mobile ITS stations, and transmitting anticipated traffic information, which is generated based on the first message, to the one or more mobile ITS stations via a second message.

To further achieve these objects and other advantages and in accordance with the purpose of the invention, as embodied and broadly described herein, according to a further different embodiment, a device for assisting a mobile ITS station in determining a moving path includes a transceiver configured to receive a first message including at least one of (a) information on one or more predictive locations and (b) a kinematic predictive value at the one or more predictive locations which are generated in consideration of a predictive moving path of each of one or more mobile ITS stations, and a processor configured to generate a second message including anticipated traffic information, which is generated in consideration of the first message received by the transceiver, and forward the second message to the transceiver. In this case, the transceiver can transmit the second message to the one or more mobile ITS stations.

According to the embodiments of the present invention, since it is able to more efficiently determine a moving path of a vehicle in consideration of a predictive moving path of a V2X vehicle instead of simply determining a moving path of a vehicle based on current traffic information, it is able to reduce traffic congestion.

And, since it is able to provide a service based on a predictive path while influencing a minimum impact on a legacy V2X communication scheme, it is able to increase technology utilization.

Effects obtainable from the present invention may be non-limited by the above mentioned effect. And, other unmentioned effects can be clearly understood from the following description by those having ordinary skill in the technical field to which the present invention pertains.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating an external structure of a vehicle according to one embodiment of the present invention;

FIG. 2 is a diagram illustrating a protocol stack of a mobile ITS station according to one embodiment of the present invention;

FIG. 3 is a diagram for explaining a message service operation according to one embodiment of the present invention;

FIG. 4 is a diagram illustrating an example of transmitting a pre-CAM via WSM according to one embodiment of the present invention;

FIGS. 5 and 6 are flowcharts for explaining a process in the aspect of a transmitter of a pre-CAM and a process in the aspect of a receiver according to one embodiment of the present invention;

FIG. 7 is a flowchart for explaining a process of changing a moving path using a pre-CAM according to one embodiment of the present invention;

FIG. 8 is a flowchart for explaining a priority of transmitting a pre-CAM according to one embodiment of the present invention;

FIGS. 9 to 11 are diagrams for explaining examples of applying and managing embodiments of the present invention.

### DETAILED DESCRIPTION OF THE INVENTION

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide a thorough understanding of the present invention. However, it will be apparent to those skilled in the art that the present invention may be practiced without such specific details.

Such a term as a ‘mobile ITS station’ described in the following description may correspond to a smart vehicle itself supporting vehicle to vehicle communication, a separate station carried by a user in a vehicle, an OBU (on-board unit), or a UE (user equipment). In the following, for clarity, the present invention is explained with an example of DSRC among V2X technologies, by which the present invention may be non-limited. The contents proposed by the present invention can also be identically applied to 3GPP-based V2X or eV2X.

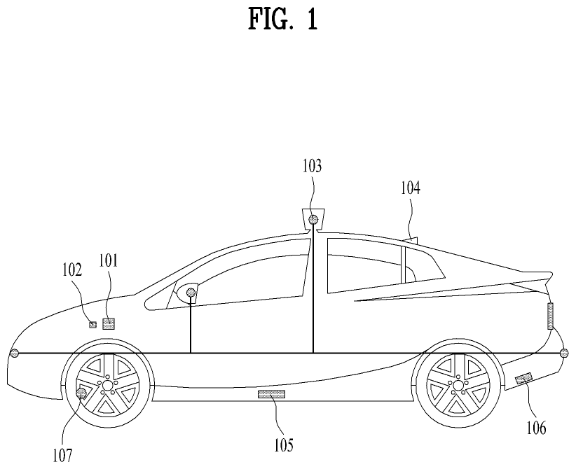

FIG. 1 is a diagram illustrating an external structure of a vehicle according to one embodiment of the present invention.

According to one embodiment of the present invention, a vehicle can include a CAN-BUS (controller area network BUS) 101, a TCU (telematics control unit) 102, an autonomous vehicle imaging and scanning unit 104, a V2X communication unit 105, and the like. The CAN-BUS 101 plays a role of an internal communication bridge between electronic control units in the vehicle and the TSU 102 can connect the CAN-BUS 101 with an external system. The autonomous vehicle imaging and scanning unit 104 can process information around the vehicle using LIDAR, radar, ultrasonic sensor, or an external camera. The V2X communication unit 105 can perform communication using the aforementioned DSRC/3GPP-based V2X scheme.

In the following description, a processor of a mobile ITS station may correspond to a processor of a station separately carried by a user in a vehicle, the TCU 102 in the aforementioned configuration, or a CPU (not depicted). And, in the following description, a transceiver of a mobile ITS station may correspond to a transceiver of a station separately carried by a user in a vehicle or the V2X communication unit 105 in the aforementioned configuration.

Meanwhile, a smart vehicle shown in FIG. 1 can more efficiently provide convenience to a user through a timer pressure senor 107, an external data storing unit 105, a third party monitoring unit 106, and the like, by which the present invention may be non-limited.

As mentioned in the foregoing description, one embodiment of the present invention intends to propose a method of more efficiently determining a moving path of a vehicle in consideration of a predictive moving path of the vehicle of a V2X vehicle rather than simply determining a moving path of a vehicle based on current traffic information. To this end, a mobile ITS station according to one embodiment of the present invention transmits a first message including at least one of (a) information on one or more predictive locations and (b) a kinematic predictive value at the one or more predictive locations in consideration of a first predictive moving path of the mobile ITS station, receives anticipated traffic information, which is generated based on the first message, via a second message, and determines whether to change the first predictive moving path with a second predictive moving path based on the anticipated traffic information received via the second message.

In this case, the first message can be transmitted in a form of a CAM (cooperative awareness message). In the following, in order to distinguish the CAM from a legacy CAM, the CAM is referred to as a ‘pre-CAM’ as a CAM based on predictive information. The pre-CAM can be transmitted via a legacy CAM/BSM. The pre-CAM shall be described in more detail in the following.

Meanwhile, the second message can be received in a form of an LDM (local dynamic map). Since the second message includes predictive traffic information, which is generated in consideration of at least one selected from the group consisting of information on a current location, kinematic information corresponding to the current location, information on a predictive location, and a kinematic predictive value at the predictive location, the second message can be referred to as a ‘pre-LDM’.

In particular, in order to implement a mechanism of determining a moving path for preventing traffic congestion based on the pre-LDM, which is generated based on the pre-CAM, the present invention proposes embodiments described in the following.

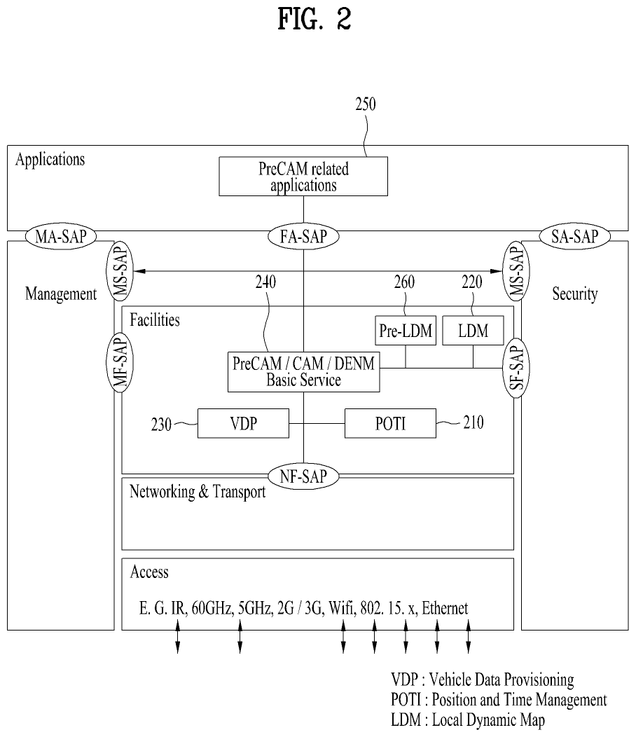

FIG. 2 is a diagram illustrating a protocol stack of a mobile ITS station according to one embodiment of the present invention.

Currently, discussion on a protocol stack for supporting V2X in LTE-A/NR is in progress. A protocol stack shown in FIG. 2 illustrates an additional configuration for supporting the present invention based on a protocol stack of ITS-G5. It is apparent to those skilled in the art that the present invention is applicable to a protocol stack to be regulated based on LTE/NR in the same principle through the following description.

In an embodiment of FIG. 2, a POTI (position and time management) 210 function can provide a vehicle with location data (longitude, latitude, and altitude) and time information necessary for the vehicle to generate a message and to operate an application 250. To this end, an internal clock of the vehicle can be synchronized with a GPS providing GMT (global management time) that provides the same time information to all ITS stations. The accuracy of the GPS can be determined as accurate as possible through information of the CAN-BUS based on changes of direction and speed of the vehicle, information utilizing “path history” received via the CAM, and the like.

The abovementioned data can be consistently used by an application of the LDM 220. In particular, if “ITTS-R emulation” application subscribes to an LDM MGNT function, a location of the vehicle can be delivered according to a given frequency (e.g., every 15 seconds).

A VDP (vehicle data provisioning) 230 entity can provide a vehicle data from the CAN-BUS with a fixed period (e.g., every 50 msec) based on electronic capability of the vehicle. The data is stored in the LDM and can be shared by function entities (a message application entity and a management function entity) requiring the data. If it is difficult to access the CAN-BUS, the vehicle does not transmit the CAM. Instead, the vehicle can transmit a DENM (decentralized environmental notification message) that triggering or termination is manually determined or is determined by a regional controller.

The LDM 220 can make a dynamically moving object to be positioned while the vehicle is moving and can locally store the object in a database. Each of objects (vehicle, traffic light, ITSS-R, POI, etc.) can be associated with various dynamic data elements (e.g., a location, speed, and a direction of a vehicle) useful for an application and other system function entities. And, if an ITS station has an LDM, the ITS station itself may become a part of the LDM.

When applications and other CPU function entities perform an operation of comparing paths of vehicle with each other in consideration of danger on a road, and the like, an LDM management entity can make the applications and other CPU function entities access a CPU to determine whether to store data elements, whether to use the data elements, and the like. The LDM includes ‘regional’ dynamic object only. Hence, it is necessary to regulate a geographical area for a regulation of a region. To this end, the LDM management entity can manage data related to the regulated geographical area.

Meanwhile, as mentioned in the foregoing description, the present invention proposes that a CAM/DENM basic service entity 240 for the LDM 220 additionally provides a pre-CAM basic service according to one embodiment of the present invention. In particular, the CAM/DENM basic service entity provides a pre-CAM service 240 based on predictive path information in addition to a CAM/DENM based on legacy current vehicle location/path information. As mentioned in the foregoing description, the pre-CAM can include at least one of information on one or more predictive locations and a kinematic predictive value at the one or more predictive locations.

The LDM generated based on the pre-CAM can be regulated as a pre-LDM 260 irrespective of the legacy LDM 220. The pre-LDM 260 can include predictive traffic information which is generated in consideration of at least one of information on a predictive location and a kinematic predictive value at the predictive location. The example shown in FIG. 2 illustrates a case that the pre-LDM 260 is configured irrespective of the legacy LDM 220, by which the present invention may be non-limited. The legacy LDM 220 can be configured in a form that the legacy LDM includes information which is added as the pre-LDM 260.

Moreover, an application 250 for performing the pre-CAM-based operation can be added in an application level as well.

In the aforementioned scheme, the mobile ITS station may become both a transmitter and a receiver of a pre-CAM. It may basically assume that an RSE (road side entity) corresponds to a receiver of the pre-CAM. Yet, in some cases, the RSE may correspond to a transmitter transmitting a pre-CAM, which is received from the mobile ITS station, to an RSE close to a point where a problem occurs. Moreover, when an operation is performed based on 3GPP, an eNB or a gNB may receive a pre-CAM from a UE (mobile ITS station), forward the pre-CAM, or respond to the pre-CAM without any separate RSE.

Meanwhile, although it is assumed as a message based on a predictive path corresponds to a pre-CAM, in some cases, it may have a form of a pre-BSM (basic safety message).

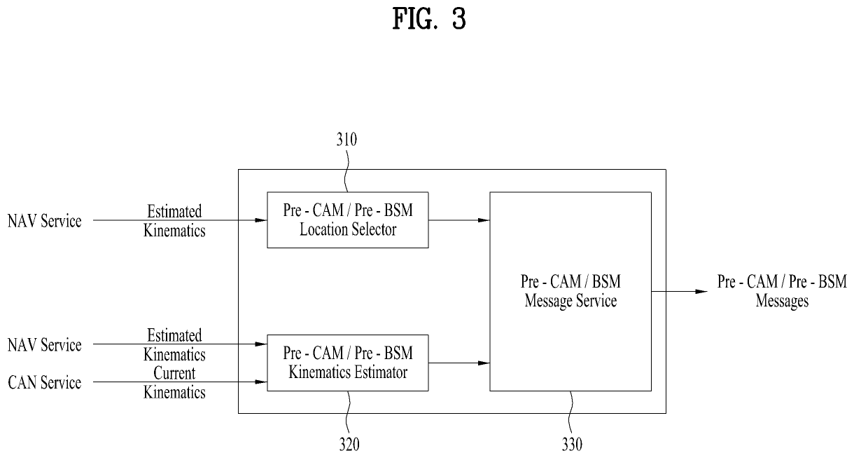

FIG. 3 is a diagram for explaining a message service operation according to one embodiment of the present invention.

As shown in FIG. 3, a pre-CAM/pre-BSM can be generated based on information obtained from navigation service of a mobile ITS station. Specifically, location information can be obtained from the navigation service of the mobile ITS station and kinematic information can be obtained from the navigation service and a CAN service.

As shown in FIG. 3, a pre-CAM/pre-BSM location selector 310 and a pre-CAM/pre-BSM kinematic estimator 320 can be separately configured. A pre-CAM/pre-BSM can be generated and transmitted via a pre-CAM/pre-BSM message service entity 330 based on a predictive location and kinematic information generated by the entities.

When the pre-CAM/pre-BSM is mentioned, the pre-CAM/pre-BSM can be commonly referred to as a ‘first message’ or a ‘pre-CAM’ for clarity. In particular, in the following description, the pre-CAM may correspond to a concept including a pre-BSM.

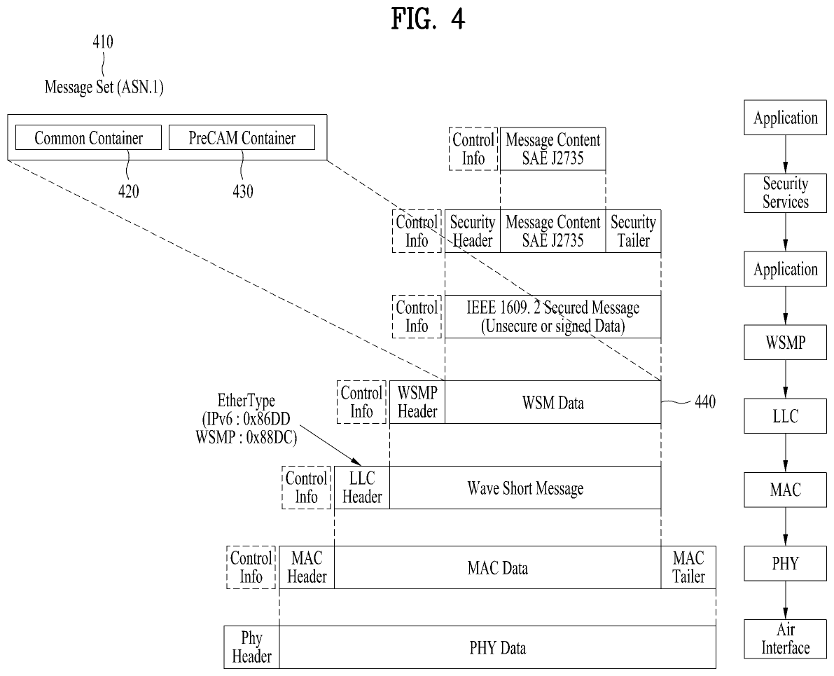

FIG. 4 is a diagram illustrating an example of transmitting a pre-CAM via WSM according to one embodiment of the present invention.

A WSM (WAVE short message) corresponds to a short message used in the aforementioned WAVE technology. However, the abovementioned pre-CAM can be transmitted not only by the WAVE scheme but also by 3GPP-based PSSCH (physical sidelink shared channel).

In the example shown in FIG. 4, a container constructing a message set 410 can include a common container 420 and a pre-CAM container 430. A message structure capable of being included in the pre-CAM container 430 is shown in the following.

TABLE 1

```
PreRange ::= SEQUENCE {
  id PreRangeReferenceID, -- globally unique
value for the PR
  dataEfficientTime  DTime,
  msgGenerationTime  DTime,
  likelihoodValue  INTEGER (1..15)
  ...
}
PreRangeList ::= SEQUENCE (SIZE(1..32)) OF PreRange
  Use: The PreRangeList data frame consists of a list of PreRange
entities.
PreCAMContainer ::= SEQUENCE {
  preLocation DF_PreRangeList
}
```

In particular, the pre-CAM can include an identifier (id) corresponding to information on each of predictive locations, data efficient time (DataEfficientTime), message generation time (msgGenerationTime), and probability information (LikelihoodValue) of passing through each of the predictive locations. In this case, it is preferable to designate the identifier (id) corresponding to information on each of predictive locations using a value unique to each PR (pre range). In Table 1, the probability information (LikelihoodValue) illustrates a probability of passing through each of the predictive locations using numbers ranging from 1 to 15, by which the present invention may be non-limited. The probability information (LikelihoodValue) can also be represented by a normal probability.

It may be preferable to include a set of the information on each of predictive locations and the probability information of passing through each of the predictive locations in the pre-CAM only when a value of the probability information is equal to or greater than a prescribed criterion. For example, a corresponding predictive location and probability information of passing through the predictive location can be included in the pre-CAM only when a probability of passing through the specific point is equal to or greater than 50%. As a different example, only one predictive path is determined as a currently predicted path and information on predictive location points passing through the predictive path can be included in the pre-CAM only.

Referring back to FIG. 4, the message set 410 including the pre-CAM container 430 can be included in a WSM data field 440 generated in a WSMP layer. The message can be wirelessly transmitted via an LLC layer, a MAC layer, and a PHY layer.

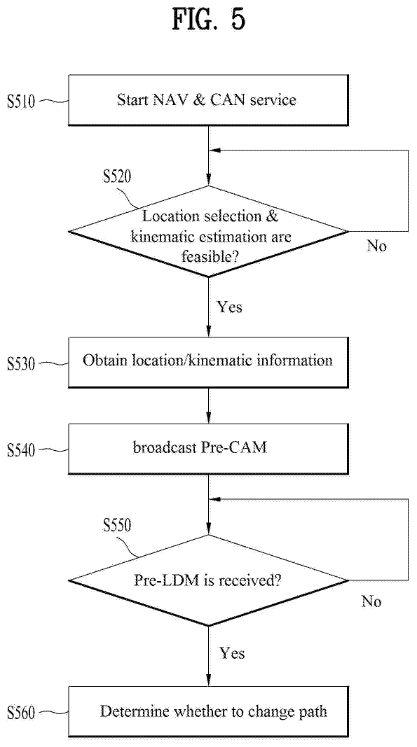

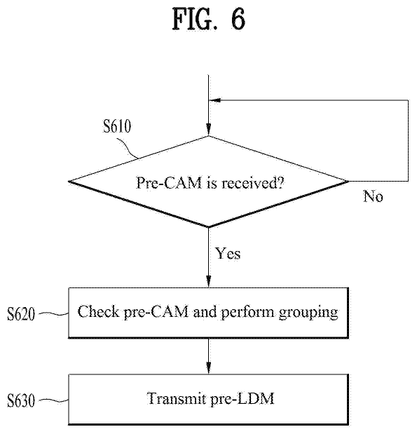

FIGS. 5 and 6 are flowcharts for explaining a process in the aspect of a transmitter of a pre-CAM and a process in the aspect of a receiver according to one embodiment of the present invention.

FIG. 5 is a flowchart for explaining a process in the aspect of a transmitter of a pre-CAM (e.g., mobile ITS station).

First of all, a mobile ITS station starts a navigation service and a CAN service [S510]. As mentioned earlier in FIG. 3, the mobile ITS station can determine whether or not the mobile ITS station is able to perform location selection and kinematic estimation based on a predictive path [S520]. As mentioned earlier in FIG. 3, if the mobile ITS station obtains location/kinematic information [S530], the mobile ITS station is able to configure a pre-CAM based on the obtained information. In this case, according to one embodiment of the present invention, the mobile ITS station can configure the pre-CAM in a manner of including information on points where a probability of passing through a specific predictive point is equal to or greater than 50% only in the pre-CAM. According to a different embodiment, the mobile ITS station can configure the pre-CAM by including information on a passing by point only in the pre-CAM according to a most preferred predictive path.

The mobile ITS station can broadcast the pre-CAM to a plurality of receiving sides [S540]. In particular, the mobile ITS station can transmit the pre-CAM not only to an RSE closest to the mobile ITS station but also to a plurality of receiving sides belonging to coverage.

The mobile ITS station can receive a pre-LDM from a receiving side (e.g., an RSE, aneNB, or a gNB) within prescribed time after the pre-CAM is transmitted [S550]. The pre-LDM can be configured in various ways and may have forms described in the following.

TABLE 2

```
PreLDMContainer ::= SEQUENCE {
  dataEfficientTime DTime,
  msgGenerationTime  DTime,
  preLDM DF_PreLDM -- Typical LDM format
```

TABLE 3

```
TSIContainer ::= SEQUENCE {
  dataEfficientTime DTime,
  msgGenerationTime  DTime,
  averageSpeed  DE_Speed,
  Density  INTEGER (1..15)
```

In particular, as shown in Table 2, the pre-LDM can include data efficient time (dataEfficientTime) and message generation time (msgGenerationTime). Additionally, the pre-LDM can include real-time traffic information (TSI) shown in Table 3 as preLDM information.

The TSI shown in Table 3 can include density information according to each of predictive locations generated in consideration of information on predictive locations received from a plurality of stations. And, as shown in Table 3, the TSI can include data efficient time, message generation time, average speed information, and the like.

In order to distinguish the TSI from information indicating an average speed and density of a specific point using current traffic state only, the TSI can also referred to as a pre-TSI. The TSI or the pre-TSI can be received in a manner of being included in the pre-LDM or can be separately received.

Having received the information, the mobile ITS station can determine whether to change an initially determined predictive moving path based on the information [S560].

Meanwhile, an operation of a receiving side of the pre-CAM is shown in FIG. 6. The receiving side of the pre-CAM may correspond to an RSE. In 3GPP-based communication, the receiving side of the pre-CAM may correspond to an eNB/gNB. The receiving side of the pre-CAM can determine whether or not the pre-CAM is received [S610]. If the pre-CAM is received, the receiving side checks the received pre-CAM and can perform grouping on the prescribed number of pre-CAM information [S620]. In this case, the grouping can be performed in consideration of predictive arrival time of each vehicle at a specific point (e.g., crossing) based on information included in the pre-CAM. The receiving side of the pre-CAM configures a pre-LDM (including a pre-TSI) based on the grouping information and can transmit the pre-LDM to the mobile ITS station or an RSE adjacent to the mobile ITS station.

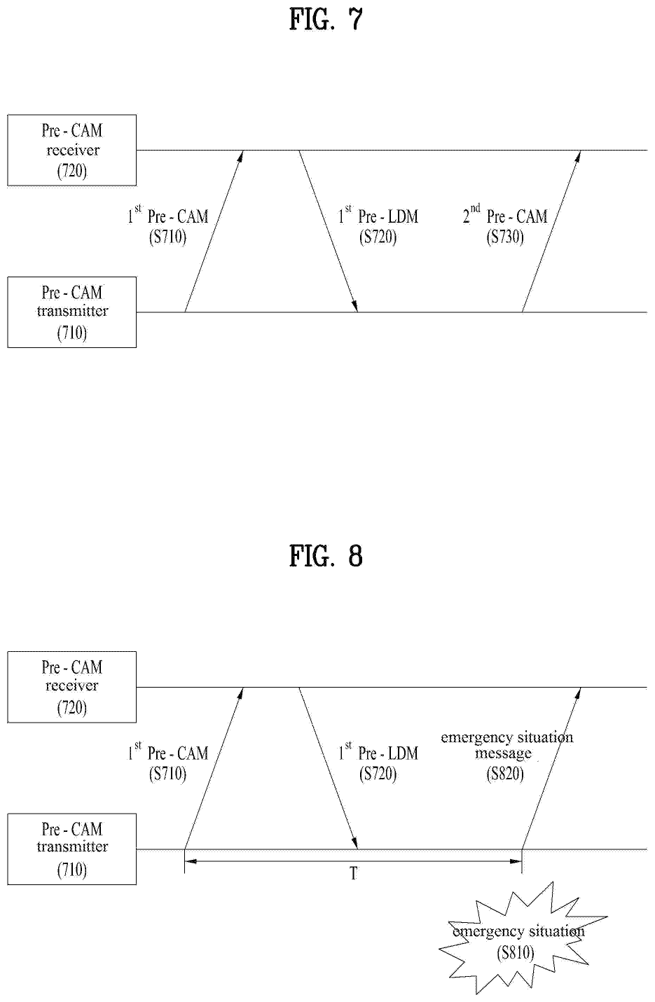

FIG. 7 is a flowchart for explaining a process of changing a moving path using a pre-CAM according to one embodiment of the present invention.

For example, if a specific vehicle transmits a pre-CAM according to an initial first predictive moving path, receives a pre-LDM according to the initial first predictive moving path, and changes a moving path with a second predictive moving path based on the pre-LDM, it may be preferable to inform a different vehicle of the changed moving path.

To this end, according to one embodiment of the present invention, a mobile ITS station periodically transmits a pre-CAM. If a predictive moving path changes, the changed predictive moving path is reflected to a next pre-CAM to solve the abovementioned problem.

Specifically, as shown in FIG. 7, if a mobile ITS station transmits a 1st pre-CAM according to a first predictive moving path [S710], the mobile ITS station can receive a Pt pre-LDM in response to the 1st pre-CAM [S720]. If the mobile ITS station changes a first predictive moving path with a second predictive moving path based on the 1st pre-LDM, the mobile ITS station can transmit a 2^{nd} pre-CAM, which is transmitted in a next period, in a manner of including the second predictive moving path in the 2^{nd} pre-CAM [S730]. Meanwhile, if the mobile ITS station does not change a predictive moving path even in a second period, the 2^{nd} pre-CAM may correspond to a message based on the first predictive moving path. In some cases, transmission can be omitted.

FIG. 8 is a flowchart for explaining a priority of transmitting a pre-CAM according to one embodiment of the present invention.

A mobile ITS station can transmit not only a data for user convenience but also information related to safety. In most cases, the information related to safety corresponds to information of high reliability and information very sensitive to latency.

In particular, one embodiment of the present invention proposes a method of managing a priority for transmitting the aforementioned pre-CAM with a priority lower than a priority for transmitting information (e.g., emergency situation message) related to safety.

Specifically, in an example shown in FIG. 8, transmission of the 1st pre-CAM [S710] and reception of the 1st pre-LDM [S720] are identical to what is mentioned earlier in FIG. 7.

Yet, if an emergency situation occurs in a vehicle at the time of transmitting a 2^{nd} pre-CAM, a message related to the emergency situation is transmitted instead of the 2^{nd} pre-CAM [S820].

Whether or not it is feasible to transmit the message related to the emergency situation and the 2^{nd} pre-CAM at the same time can be determined in consideration of a transmit power constraint of the mobile ITS station, a constraint of a resource region, and the like.

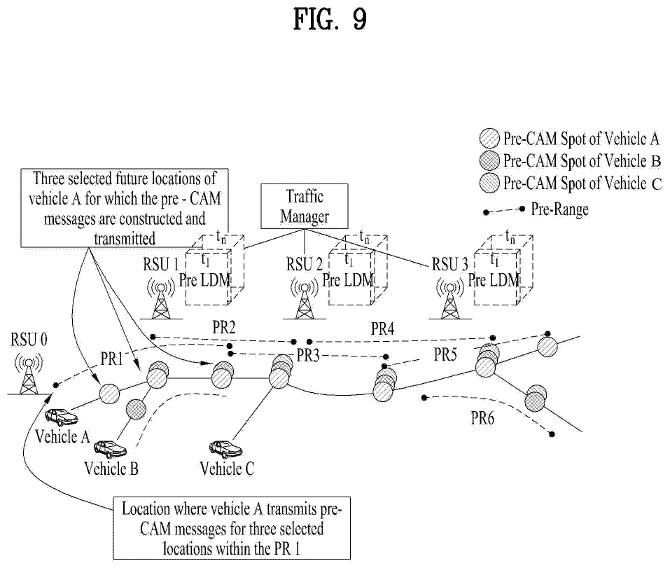

FIGS. 9 to 11 are diagrams for explaining examples of applying and managing embodiments of the present invention.

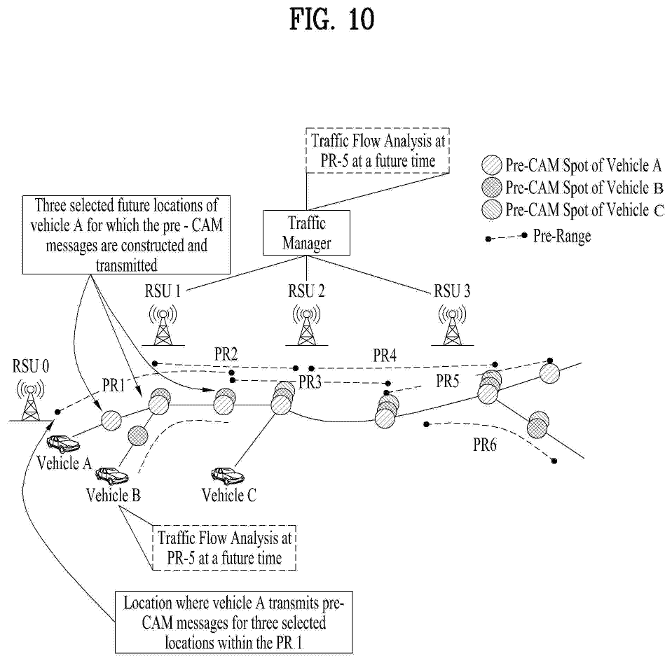

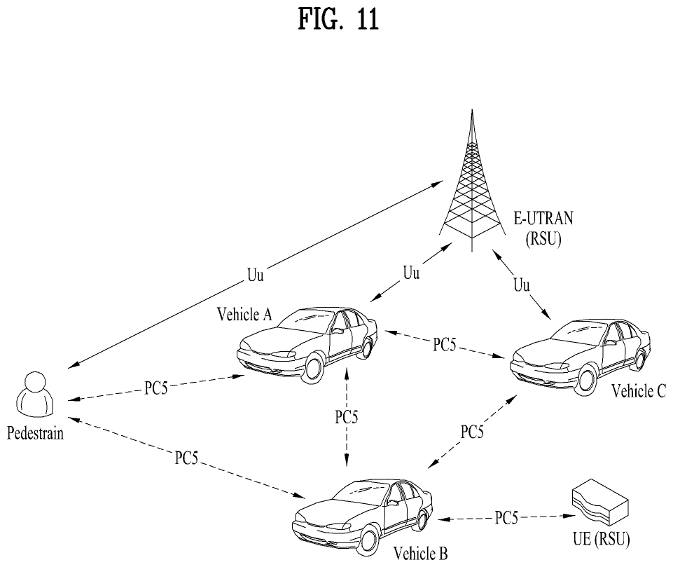

Specifically, FIGS. 9 and 10 are diagrams for explaining an example of operating based on a DSRC and FIG. 11 is a diagram for explaining an example of operating based on 3GPP LTE-A or NR. And, FIG. 9 illustrates a case that an RSU (road side unit) generates a pre-LDM and FIG. 10 illustrates a case that an entity managing a plurality of RSUs generates a pre-LDM.

In the examples of FIGS. 9 and 10, a vehicle A can transmit information on 3 crossings represented by arrows in FIGS. 9 and 10 using a pre-CAM based on a predictive moving path of the vehicle A. In FIGS. 9 and 10, PR1 corresponds to a range including the 3 crossings and PR2 to PR6 also indicate a concept including crossings within a prescribed range.

A vehicle B and a vehicle C can also transmit a pre-CAM to a corresponding RSU in consideration of locations and predictive paths of the vehicle B and the vehicle C using the same method.

Meanwhile, referring to FIG. 9, each of RSUs (RSU 1, RSU 2, and RSU 3) configures a pre-LDM based on a received pre-CAM. On the contrary, referring to FIG. 10, a traffic manager managing the RSU 1 to RSU 3 configures a pre-LDM for 5 PRs.

In particular, each of the vehicles can determine whether to maintain/change a moving path of the vehicle based on a generated pre-LDM.

Meanwhile, unlike FIGS. 9 and 10, FIG. 11 illustrates a case of using an interface based on 3GPP LTE-A. Although NR based interface is used, the same scheme can be applied.

In 3GPP based cellular system, an interface between a UE and E-UTRAN via an eNB/gNB is defined as Uu interface, a link from the UE to E-UTRAN is defined as an uplink, and a link from E-UTRAN to the UE is defined as a downlink. And, as shown in FIG. 11, a link between UEs is defined as a PC5 interface and the PC5 interface is defined as a sidelink in a lower layer.

As shown in FIG. 11, the eNB/gNB of E-UTRAN or a specific UE may operate as an RSU.

According to one embodiment of the present invention, if each of a vehicle A, a vehicle B, and a vehicle C generates a pre-CAM based on predictive moving path information of its own, each of the vehicles can transmit the pre-CAM to E-UTRAN via the Uu interface or transmit the pre-CAM to a different UE via the PC5 interface. In particular, as mentioned in the foregoing description, this can be differently determined depending on an entity operating as an RSU among E-UTRAN and the different UE. In some cases, since a mobile ITS station of a vehicle, which is located within the coverage of E-UTRAN, is determined as in-coverage UE, the mobile ITS station transmits a pre-CAM to E-UTRAN. On the contrary, since a mobile ITS station of a vehicle, which is located outside of the coverage of E-UTRAN, is determined as out-of-coverage UE, the mobile ITS station transmits a pre-CAM to a different UE (e.g., sync reference UE).

As mentioned in the foregoing description, if E-UTRAN/UE receives a pre-CAM, the UTRAN/UE can configure a pre-LDM by performing grouping on one or more pre-CAM information. A method of performing grouping may vary depending on a receiver of the pre-CAM among E-UTRAN and a different UE. If the pre-LDM is configured, E-UTRAN/UE can transmit the pre-LDM to a mobile ITS station of each of the vehicles via a downlink/sidelink.

As mentioned in the foregoing description, the detailed descriptions for the preferred embodiments of the present invention are provided to be implemented by those skilled in the art. While the present invention has been described and illustrated herein with reference to the preferred embodiments thereof, it will be apparent to those skilled in the art that various modifications and variations can be made therein without departing from the spirit and scope of the invention. Therefore, the present invention is non-limited by the embodiments disclosed herein but intends to give a broadest scope matching the principles and new features disclosed herein. While the present specification has been described and illustrated herein with reference to the preferred embodiments and diagrams thereof, the present specification may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

And, both an apparatus invention and a method invention are explained in the present specification and the explanation on the both of the inventions can be complementally applied, if necessary.

1. A method of determining a moving path of a mobile ITS (intelligent transport system) station, the method comprising:
transmitting a first message containing at least one of (a) information on one or more predictive locations and (b) a kinematic predictive value at the one or more predictive locations that are generated in consideration of a first predictive moving path of the mobile ITS station;
receiving a second message containing anticipated traffic information which is generated based on the first message; and
determining, by the mobile ITS station, whether to change the first predictive moving path to a second predictive moving path based on the anticipated traffic information received via the second message.

2. The method of claim 1, wherein the first message is generated based on information obtained from a navigation service of the mobile ITS station.

3. The method of claim 1, wherein the first message contains:
an identifier corresponding to information on each of the one or more predictive locations,
data efficient time,
message generation time, and
information on a probability of passing through the each predictive location.

4. The method of claim 3, wherein a set of the information on each of the one or more predictive locations and the information on the probability of passing through the each predictive location is contained in the first message only when a value of the information on the probability of passing through the each predictive location is equal to or greater than a prescribed value.

5. The method of claim 1, wherein the second message contains density information per predictive location which is generated in consideration of information on predictive locations received from a plurality of stations containing the mobile ITS station.

6. The method of claim 1, wherein the first message contains information on arrival anticipated time corresponding to each of the information on the one or more predictive locations, and
wherein the second message contains anticipated traffic information which is generated in consideration of the information on each of the predictive locations and the information on the arrival anticipated time.

7. The method of claim 1, wherein the first message is transmitted via a CAM (cooperative awareness message) by additionally containing information on a current location and kinematic information corresponding to the current location.

8. The method of claim 1, wherein the second message is received in a form of an LDM (local dynamic map) containing anticipated traffic information, which is generated in consideration of at least one of:
information on a current location, kinematic information corresponding to the current location, the information on the predictive location, and a kinematic predictive value at the predictive location.

9. The method of claim 1, wherein the mobile ITS station periodically transmits the first message, and
wherein if the mobile ITS station changes the first predictive moving path to the second predictive moving path in a first period according to a transmission of the first message and a reception of the second message, the first message transmitted in a second period after the first period contains information which is generated in consideration of the second predictive moving path.

10. The method of claim 9, wherein if the mobile ITS station needs to transmit an emergency signal at a timing corresponding to a period for which the first message is to be transmitted, the mobile ITS station assigns a higher priority to the emergency signal than the first message and transmits the emergency signal.

11. A mobile ITS (intelligent transport system) station for determining a moving path based on information on a predictive location, the mobile ITS station comprising:
a transceiver configured to transmit and receive signals; and
a processor configured to:
generate a first message containing at least one of information on one or more predictive locations and a kinematic predictive value at the one or more predictive locations that are generated in consideration of a first predictive moving path of the mobile ITS station,
transmit, via the transceiver, the generated first message to a device,
receive, via the transceiver, a second message containing anticipated traffic information; which is generated based on the first message,
process the received second message, and
determine whether to change the first predictive moving path to a second predictive moving path based on the anticipated traffic information received via the second message.

12. The mobile ITS station of claim 11, further comprising a navigation system configured to provide a navigation service,
wherein the processor is configured to generate the first message based on information obtained from the navigation system.

13. The mobile ITS station of claim 11, wherein the processor comprises:
an application for determining a moving path based on a predictive location in an application layer,
a message management function block for managing the first message, and
a function block for managing the second message.

14. The mobile ITS station of claim 13, wherein the message management function block for managing the first message contains a CAM (cooperative awareness message) management function block, and
wherein the function block for managing the second message contains an LDM (local dynamic map) management function block.

15. A method of assisting a mobile ITS (intelligent transport system) station in determining a moving path, the method comprising:
receiving, by a device, a first message containing at least one of (a) information on one or more predictive locations and (b) a kinematic predictive value at the one or more predictive locations which are generated in consideration of a predictive moving path of each of one or more mobile ITS stations;
generating a second message containing anticipated traffic information, which is generated based on the first message; and
transmitting, by the device to the one or more mobile ITS stations, the generated second message.

16. A device for assisting a mobile ITS (intelligent transport system) station in determining a moving path, the device comprising:
a transceiver configured to receive a first message containing at least one of (a) information on one or more predictive locations and (b) a kinematic predictive value at the one or more predictive locations which are generated in consideration of a predictive moving path of each of one or more mobile ITS stations; and
a processor configured to generate a second message containing anticipated traffic information, which is generated in consideration of the first message received by the transceiver, and provide the generated second message to the transceiver,
wherein the transceiver is configured to transmit the generated second message to the one or more mobile ITS stations.

17. The method of claim 15, wherein the second message containing the anticipated traffic information is used in determining whether to change a predictive moving path of a vehicle to another predictive moving path.

18. The method of claim 15, wherein the second message contains density information per predictive location which is generated in consideration of information on predictive locations received from the one or more mobile ITS stations.

19. The device of claim 16, wherein the second message containing the anticipated traffic information is used in determining whether to change a predictive moving path of a vehicle to another predictive moving path.

20. The device of claim 16, wherein the second message contains density information per predictive location which is generated in consideration of information on predictive locations received from the one or more mobile ITS stations.
